(19) United States
(12) Patent Application Publication
(10) Pub. No.: US 2026/0217310 A1
(43) Pub. Date: Jul. 30, 2026

(54) METHODS AND APPARATUS FOR A STEER-BY-WIRE STEERING SYSTEM

(71) Applicant: Ford Global Technologies, LLC, Dearborn, MI (US)

(72) Inventors: Oliver Nehls, Dusseldorf (DE); Sergio Codonesu, Aachen (DE); Hannah Eileen Denomme, South Lyon, MI (US); Brian Christopher Branham, Grass Lake, MI (US)

(21) Appl. No.: 19/465,872

(22) Filed: Jan. 30, 2026

(30) Foreign Application Priority Data
Jan. 30, 2025 (EP) 25155073.7

(51) Int. Cl. B62D 6/00; B62D 5/04

(52) U.S. Cl. CPC B62D 6/008; B62D 5/0463

(57) ABSTRACT

The disclosure generally relates to steer-by-wire steering systems and, more particularly, to methods and apparatus for a steer-by-wire (SBW) steering system. An example a vehicle comprising a hand wheel actuator, a road wheel actuator, and a steering controller to instantiate or execute machine readable instructions to determine a speed of a steering input to the hand wheel actuator, determine an acceleration of the steering input, and in response to the acceleration being a deceleration larger than a first threshold and the speed being below a second threshold, apply a gradient torque limit to the road wheel actuator.

### RELATED APPLICATION

This patent claims priority from EP Patent Application Number EP25155073.7, which was filed on January 30, 2025, and is hereby incorporated herein by reference in its entirety.

### FIELD OF THE DISCLOSURE

The disclosure generally relates to steer-by-wire steering systems and, more particularly, to methods and apparatus for a steer-by-wire (SBW) steering system.

### BACKGROUND

Steer-by-Wire (SBW) is a new automotive steering technology, that is an evolution of Electric Power Assisted Steering (EPAS) systems. EPAS systems include a mechanical linkage to transmit a driver input at the steering wheel directly to the road wheels. In SBW steering systems, the mechanical linkage is eliminated, and two actuator sub-systems work together to steer the vehicle. A hand wheel actuator (e.g., a feedback actuator (FBA)) generates a feedback torque for the driver at the steering wheel and generates a steering command, and a road wheel actuator (RWA) controls the steerable road wheels to the desired position based on the steering command.

### SUMMARY

An example a vehicle comprising a hand wheel actuator, a road wheel actuator, and a steering controller to instantiate or execute machine readable instructions to determine a speed of a steering input to the hand wheel actuator, determine an acceleration of the steering input, and in response to the acceleration being a deceleration larger than a first threshold and the speed being below a second threshold, apply a gradient torque limit to the road wheel actuator.

An example non-transitory computer readable storage medium comprising instructions to cause programmable circuitry to at least determine a speed of a steering input to a hand wheel actuator of a vehicle, determine an acceleration of the steering input, and in response to the acceleration being a deceleration larger than a first threshold and the speed being below a second threshold, apply a gradient torque limit to a road wheel actuator of the vehicle.

An example method comprising determining a speed of a steering input to a hand wheel actuator of a vehicle, determining an acceleration of the steering input, and in response to the acceleration being a deceleration larger than a first threshold and the speed being below a second threshold, applying a gradient torque limit to a road wheel actuator of the vehicle.

### BRIEF DESCRIPTION OF DRAWINGS

FIG. 1 depicts a vehicle including a SBW steering system in accordance with examples described herein.

FIG. 2 is a flowchart representative of example machine readable instructions and/or example operations that may be executed, instantiated, and/or performed by example programmable circuitry to implement the SBW steering system of FIG. 1.

FIG. 3 is a flowchart representative of example machine readable instructions and/or example operations that may be executed, instantiated, and/or performed by example programmable circuitry to implement the SBW steering system of FIG. 1.

FIG. 4 is a block diagram of an example processing platform including programmable circuitry structured to execute, instantiate, and/or perform the example machine readable instructions and/or perform the example operations of FIGS. 2 and 3 to implement the SBW steering system of FIG. 1.

### DETAILED DESCRIPTION

A key benefit of SBW steering systems is the use of a vehicle speed dependent variable steering ratio (VGR) that can dynamically change a rack travel of a steering rack of the SBW steering system in response to a given steering wheel angle. This is achieved as the VGR is not dependent on or limited by a mechanical ratio. A standard VGR implementation creates a more direct steering ratio at lower vehicle speeds and blends into a ratio that is less reactive to small inputs at higher vehicle speeds.

During operation of the SBW steering system, noise (e.g., a clunk noise) can be generated under specific circumstances. For example, noise is generated when the steering rack quickly stops or rapidly changes the direction of the rack travel. Due to the very direct ratio of the VGR and, therefore, significantly higher rack speeds of the steering rack at low vehicle speeds, such as during parking operations, typical noise issues at the road wheel actuator (RWA) of SBW steering systems are significantly amplified as compared to previous steering systems that have more indirect steering ratios.

In general, noise is known to occur in steering systems that use a steering rack. However, RWAs can also be coupled to steerable road wheels without a steering rack. For example, RWAs can include electric motors which are individually coupled to steerable road wheels. However, noise can also occur in view of the alternative coupling structures if the RWA(s) is/are differently coupled to steerable road wheels that do not include a steering rack.

Known solutions to reducing noise in SBW steering systems focus on generally influencing control mechanisms of the steering system, modifying design properties of the underlying steering system, or altering the number of output signals produced by steering angle sensors. Examples disclosed herein include at least a roadwheel actuator (RWA) and a control device. The RWA includes an electric motor coupled to steerable road wheels of a vehicle. An example method described herin includes least the following operations. First, a steering angle request is received by a control device. The steering angle request defines a target angle for steerable road wheels of the vehicle being coupled to the RWA. The target angle defined by the steering angle request is compared by the control device to at least one preceding target angle of at least one preceding steering angle request of at least one preceding control period. A target angle speed is determined by the control device based on the present target angle and the at least one preceding target angle. An adapted target angle and/or at least one adapted property of the RWA is determined by the control device. A control signal for the electric motor is determined by the control device based on at least the steering angle request, the adapted target angle and/or the adapted property of the RWA. Finally, the control signal is output by the control device to the RWA.

Examples disclosed herein are based on the knowledge that the steering wheel and the RWA are disconnected. Therefore, the target angle and/or at least one property of the RWA can be modified independently from the steering wheel movement. Accordingly, the influence of the steering demand of the SBW system can be adapted. Modifications are applied to the target angle and/or at least one property of the RWA. Accordingly, the methods described herein enable adjustments such that noise potentially caused by the SBW steering system is reduced or even prevented.

Examples described herein implement specific countermeasures for noise generated by a SBW steering system. These countermeasures can be applied during regular use of the SBW steering system. Accordingly, methods described herein are not limited to the design phase in that the entire SBW steering system is required to be configured differently to prevent noise. Rather, examples described herein provide a specific control procedure such that modifications are applied to the SBW steering system to prevent noise during regular operation. Therefore, methods described herein are configured to be retrofitted to existing SBW steering systems, for example, by updating a control software or a firmware of a control device of the SBW steering system.

In some examples, the RWA is coupled via a rack to at least one steerable road wheel. In an alternative, the RWA can also be coupled to two steerable road wheels via a single steering rack. According to a further alternative, the RWA can also be differently coupled to at least one steerable road wheel without the use of a steering rack. In any case, a force is transmitted from an electric motor of the RWA which causes the steering angle of at least one steerable road wheel to align according to a specific direction. The change of the torque output by the at least one electric motor of the RWA can cause noise which is reduced or eliminated by the method described herein. In the following, the different aspects are explained in view of a coupling structure being assumed to provide a coupling between the RWA and the steerable road wheels. In some examples, the coupling structure may be a steering rack. However, the respective explanations can be correspondingly transferred to alternative topologies where a steering rack is omitted, and the coupling structure is configured differently for transmitting the force.

In some examples, the adapted target angle and/or the at least one adapted property of the RWA is determined only if the target angle speed exceeds a first target angle speed threshold, and/or a vehicle speed of the vehicle is determined by the control device to be within a first vehicle speed threshold range, and/or the present target angle indicates an impending change of a direction of the target angle, and/or the present target angle indicates an impending stop of a steering movement. Therefore, multiple different scenarios are considered as to when the adapted target angle and/or the adapted property of the RWA is to be determined. These scenarios may also be considered “entry conditions” for the adaption of the various parameters. However, in an alternative, the adaptation of the specific parameters may also be performed independently of these entry conditions (e.g., permanently).

In some examples, based on the entry conditions, configurations can be excluded where only rather small target angle speeds are employed which commonly do not cause noise. The target angle speed threshold can be set accordingly to adapt the methods described herein to the particular system. In addition, the method described herein may be vehicle-speed dependent. Since the VGR of the SBW steering system is commonly configured such that the most direct steering ratio is provided at low vehicle speeds, the probability that a user of the SBW steering system notices noise is highest at low vehicle speeds. Therefore, by restricting the disclosed method to particular vehicle speed ranges, the method is applied in the vehicle operating conditions where it is most relevant. In addition, the method can evaluate, based on the current target steering angle, whether a change in direction or a stop of the movement is likely to occur in the near future. If the circumstances indicate that a change of the direction of movement or a stop of the movement may take place in near future, noise may occur such that the determination of the adapted target angle and/or at least one adapted property of the RWA can be initiated.

In some examples, the first vehicle speed threshold range is limited between [-x; x], wherein x denotes a first vehicle speed threshold. The first vehicle speed threshold may be 10 km/h, 15 km/h, 20 km/h, 25 km/h, 30 km/h, etc.

In some examples, a determination of the adapted target angle and/or the at least one adapted property of the RWA is deactivated if a direction of the present target angle compared to the at least one preceding target angle is changed relative to the reference direction and a tolerance time period has passed, or the target angle speed is larger than a second target angle speed threshold, and/or a first time period has passed after the control device determined that the present target angle indicates an impending change of a direction of the target angle, or that the present target angle indicates an impending stop of a steering movement, and/or the present target angle speed is smaller than a third target angle speed threshold for a second time period, and/or the direction of the present target angle compared to the at least one preceding target angle did not change relative to the reference direction and the present target angle speed is larger than at least one preceding target angle speed of at least one preceding control period, and/or the vehicle speed of the vehicle is determined to exceed a second vehicle speed threshold range.

Accordingly, multiple scenarios are contemplated to determine when the adapted parameters are no longer required (e.g., since a change of the direction of the present target angle did not occur or since sufficient time has passed after the change of the direction of the target angle did take place). These scenarios may be referred to as “exit conditions.” In these cases, the limitation of the adapted target angle and/or the at least one adapted property of the RWA can be lifted and the SBW system can be operated at regular procedures.

In some examples, deactivating of the adapted target angle and/or the at least one adapted property of the RWA is considered only if the determination was activated based on one of the entry conditions described herein. Alternatively, deactivating the determination procedure of the adapted target angle and/or the at least one adapted property of the RWA can also be entirely avoided. For example, the determination procedure of the adapted target angle and/or the at least one adapted property of the RWA can be active all time.

In some examples, the second vehicle speed threshold is limited insofar that for actual vehicle speeds z, with z < -y or z > y, the exit condition is met. Y denotes a second vehicle speed threshold. The second vehicle speed threshold can correspond to the first vehicle speed threshold described herein before. In some examples, the second vehicle speed threshold is equal to the first vehicle speed threshold. Alternatively, the second vehicle speed threshold may be different from the first vehicle speed threshold, for example, larger than the first vehicle speed threshold. Accordingly, hysteresis is provided such that a more stable control procedure is achieved omitting fluctuating behavior. In an alternative y can also correspond to y = x + Δv, where Δv is 5 km/h, 3 km/h, etc.

In some examples, if an exit condition is met and the at least one property of the RWA was adapted, the at least one property of the RWA is modified to an initial property before the adaptation. Accordingly, the SBW system can return to initial properties before any adaptation was initiated.

In some examples, a control device may determine a ramp parameter. The control device enables and/or disables a change between the present target angle and the adapted target angle and/or between an unmodified property of the RWA and the adapted property of the RWA based on the ramp parameter. The ramp parameter generally ensures a smooth transition between the regular configuration including the present target angle and the unmodified property of the RWA and the adapted configuration including the adapted target angle and/or the adapted property of the RWA. Therefore, abrupt effects can be prevented such that the comfort of the driver is enhanced.

In some examples, the ramp parameter can be considered when the determination of the adapted target angle and/or the adapted property of the RWA is activated or deactivated based on at least one entry condition or exit condition. Thus, the ramp parameter can also be considered when performing a transition back from the adapted configuration to the regular configuration, once the modification achieved by the method is unnecessary, for example if the vehicle speed exceeds a respective vehicle speed threshold.

In some examples, the at least one adapted property of the RWA is based on a motor torque gradient limiter configured to limit a torque gradient (e.g., currently applied torque) of a torque output by the electric motor of the RWA to be smaller than a torque gradient threshold. The motor torque gradient refers to the rate of change of the motor torque. By limiting the motor torque gradient, the speed at which the motor torque can change is limited. For example, the rate of the change of the motor torque is limited such that the changes in torque are less abrupt. Based on the limited torque gradient, a sudden removal or reversal of the motor torque can be prevented, which elsewise would cause noise. In some examples, the gradient limitation applied by the motor torque gradient limiter can be applied before and during the reversal of the change of the direction of the target angle relative to the reference direction (e.g., the change of the direction of movement of the coupling structure). In some examples, the torque gradient may be limited based on at least one of a first constant value, the vehicle speed, the torque applied by the electric motor of the RWA, the target angle speed, a derivative of the target angle speed, and/or the present target angle.

In some examples, the torque gradient can be limited to be reduced with increasing vehicle speeds. Alternatively or additionally, the torque gradient can be limited to be reduced for higher torque levels. Alternatively or additionally, the torque gradient (e.g., gradient torque limit) can be limited so as to be reduced close to a turn-around point defined by the target angle speed = 0 deg/s. Alternatively or additionally, the torque gradient can be limited so as to be reduced for higher values of the derivative of the target angle speed. Alternatively or additionally, the torque gradient can be not limited if the present target angle is already close to a coupling structure end stop such that hitting the coupling structure end stop is prevented. By limiting the motor torque gradient if the present target angle is close to the coupling structure end stop, an overshooting may occur enhancing the intensity of the hit on the coupling structure end stop. Accordingly, this scenario and the stress caused thereby can be prevented when the torque gradient is not limited. Consequently, the motor torque gradient limiter can be adapted in various ways so as to adjust the limiting effect based on the specific demands of the respective SBW system. In other words, the characteristics of the motor torque gradient limiter can be adapted to specific applications.

In some examples, the adapted target angle may be based on a target angle request limiter configured to limit a derivative of the target angle (e.g., a gradient target angle limit) speed. This means that the rate of change of the target angle speed can be limited (e.g., a target angle acceleration limit can be applied). This also leads to slower changes in the movement of the coupling structure. Accordingly, noise can be reduced or prevented.

In some examples, the limitation of the derivative of the target angle speed leads to a change of the target angle. For example, if the speed is limited, the adapted target angle moves further than without the limiter, such as in view of the present (unmodified) target angle. This in turn leads to a change in path. In other words, the steering angle would initially overshoot the turn-around position and would afterwards catch-up to the desired position, namely the intended target angle (present target angle). However, this is no issue, since at low vehicle speeds the vehicle reacts slowly to the angles and the driver does not notice small and/or short deviations from the intended target angle (present target angle).

In some examples, the target angle request limiter may limit the derivative of the target angle speed based on a target angle speed derivative interval defining a negative target angle speed derivative threshold and a positive target angle speed derivative threshold. Hence, the derivative of the target angle speed can be configured in view of the respective SBW steering system. In some examples, the negative target angle speed derivative threshold and the positive target angle speed derivative threshold individually or cooperatively may depend on at least one of a second constant value, the vehicle speed, the target angle speed, and/or the present target angle.

In some examples, the threshold values can be adapted in view of the vehicle speed. Accordingly, for higher vehicle speeds, the threshold values can be comparatively small. Alternatively or additionally, the threshold values may not be limited if the present target angle is already close to a coupling structure end stop such that hitting the coupling structure end stop is prevented. By reducing the threshold values if the present target angle is close to the coupling structure end stop, an overshooting may occur enhancing the intensity of the hit on the coupling structure end stop. Accordingly, this scenario and the stress caused thereby can be prevented when the threshold values are not limited. Consequently, the threshold values of the target angle speed derivative can be adapted in various ways so as to adjust the limiting effect based on the specific demands of the respective SBW steering system.

In some examples, the adapted target angle may be based on a target angle filter, in particular a low-pass filter, applied by the control device to the present target angle. The target angle filter also provides a smoothening of the present target angle, thus, causing an adapted target angle. In some examples, the target angle filter may be a first-order low-pass filter or a higher-order low-pass filter. Thus, the target angle filter can be configured to fit the respective SBW steering system.

In some examples, a cut-off frequency and/or poles and/or zeros of the target angle filter may depend on at least one of a third constant value, the vehicle speed, the target angle speed, the derivative of the target angle speed, and/or the present target angle. For example, by adapting the cut-off frequency and/or poles and/or zeros of the target angle filter, the filtering effect (e.g., filtering efficiency) can be reduced with increasing vehicle speeds. Alternatively or additionally, the filtering effect can be reduced for higher values of the derivative of the target angle speed. Alternatively or additionally, the filtering effect can be reduced if the present target angle is already close to a coupling structure end stop such that hitting the coupling structure end stop is prevented. By reducing the filtering effect, the overshooting effect can be limited such that a hit on the coupling structure end stop may be reduced in intensity or even be prevented. Thus, the filtering effect can be configured based on the specific demands of the respective SBW steering system.

In some examples, the at least one adapted property of the RWA may be based on a modified stiffness of an angle controller of the RWA. The shape of the torque request, especially its gradients, is mainly defined by the stiffness and damping of the angle controller of the RWA. The stiffer the angle controller, the higher the gradients. The stiffer the angle controller, the better the angle tracking, but also the higher the changes of the angular speed are. In a SBW application, it is desirable that the tracking is as good as possible. However, such high stiffnesses increases the probability of noise in the SBW steering system. Therefore, to reduce or to prevent noise, the angle controller stiffness can be adapted. In some examples, the angle controller may be part of the control device.

In some examples, the stiffness of the angle controller may be modified based on at least one of a gain of the angle controller, a pole of the angle controller, and/or a zero of the angle controller. While the change of the poles or zeros of the angle controller provide an indirect modification of the angle controller performance, the modification of the gain represents a direct change. For example, a proportional gain, and/or an integral gain, and/or a differential gain of the angle controller may be adjusted in view of a PID-based angle controller included with the RWA. In some examples, the gain and/or the pole and/or the zero of the angle controller can be modified based on at least one of a fourth constant value, the vehicle speed, the target angle speed, the derivative of the target angle speed, and/or the present target angle.

In some examples, the stiffness of the angle controller can be increased with increasing vehicle speeds. Alternatively or additionally, the stiffness of the angle controller can be reduced for higher values of the derivative of the target angle speed. Alternatively or additionally, the modification of the stiffness of the angle controller can be prevented if the present target angle is already close to a coupling structure end stop such that hitting the coupling structure end stop is prevented. Therefore, overshooting which may occur for reduced stiffnesses can be prevented such that a hit on the coupling structure end stop may be reduced in intensity or even be prevented.

In some examples, the control signal for the electric motor can be determined by the control device based on additional input variables, such as the vehicle speed, the lateral velocity gradient of the vehicle, and/or other vehicle parameters. Thus, a tailored control signal is provided.

In some examples, the method described herein is a computer-implemented method. Therefore, at least one data processing device is applied to perform the method. For example, the data processing device may be part of the control device. In some examples, the disclosure also relates to a computer program product comprising instructions which, when the computer program product is executed by a processor, cause the processor to carry out the method described above. The advantages achieved by the method described herein are also achieved in a corresponding manner by the computer program product. In some examples, the disclosure also relates to a non-transitory computer-readable storage medium comprising instructions that, when the computer program product is executed by a processor, cause the processor to carry out the method described above. The advantages achieved by the method described herein are also achieved in a corresponding manner by the computer-readable storage medium.

In some examples, a SBW steering system for a vehicle is provided. The SBW steering system includes at least a RWA and a control device. The RWA includes an electric motor coupled via a coupling structure to steerable road wheels of the vehicle. Based on the control device and/or the RWA, the SBW steering system is configured for carrying out the method as described herein. The advantages achieved by the before described method are also achieved by the SBW steering system in a corresponding manner. In particular, the probability of an occurrence of noise can be reduced by the respective countermeasures, thereby enhancing the comfort of the driver. In some examples, a vehicle including a SBW steering system as explained herein is provided. The vehicle may be a hybrid vehicle, a vehicle having a combustion engine, or an electric vehicle. The advantages achieved by the before described method are also achieved by the vehicle in a corresponding manner.

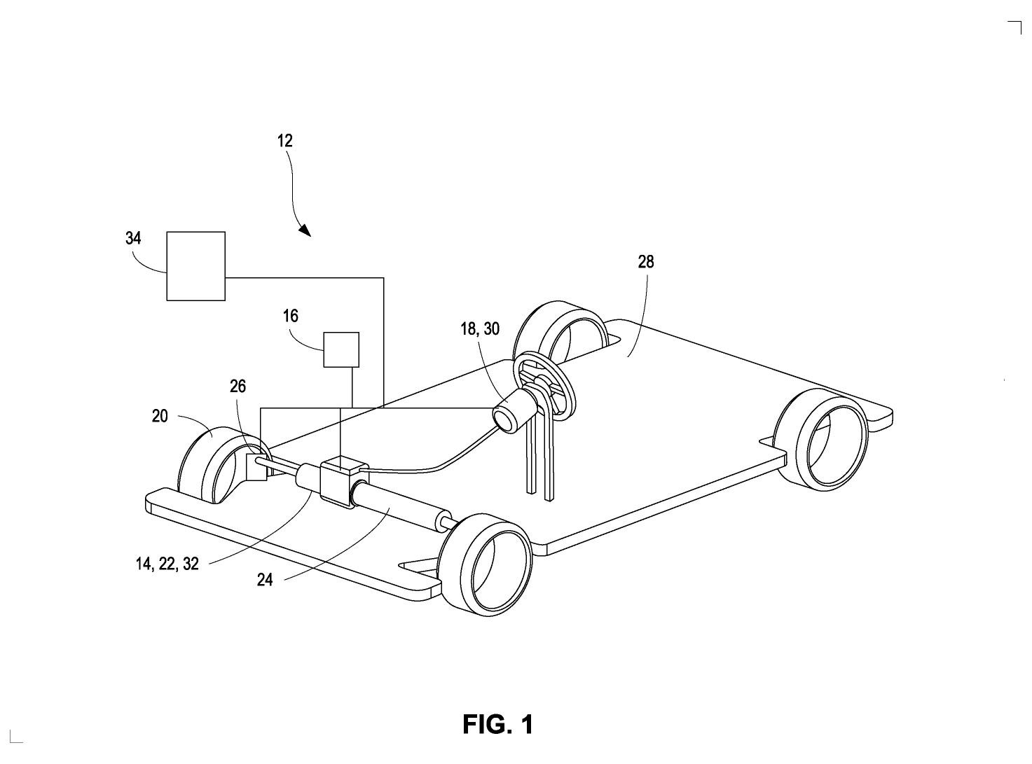

FIG. 1 shows a simplified schematic representation of a vehicle 10 with a SBW steering system 12 according to examples described herein. The SBW system 12 includes a RWA 14 and a control device 16 (e.g., steering controller). The SBW steering system 12 also includes a hand wheel actuator 18. The hand wheel actuator 18 and the RWA 14 are coupled to each other and to the control device 16. The RWA 14 is indirectly coupled to steerable road wheels 20 of the vehicle 10. The RWA 14 includes an electric motor 22 which is coupled to a coupling structure 24 (e.g., a steering rack). The coupling structure 24 is coupled to the steerable road wheels 20 of the vehicle 10. The displacement of the coupling structure 24 in view of a reference position, such as a zero position (straight position), leads to a change of the orientation of the steerable road wheels 20 about the steering axes of the respective wheels 20.

The SBW steering system 12 includes a sensor 26 that is configured to detect an operating parameter of the SBW steering system 12 that is influenced by the operation of the RWA 14, such as a steering angle of the steerable road wheels 20 or a coupling structure travel of the coupling structure 24. In some examples, the sensor 26 can also be configured as a torque sensor that is configured to detect the torque output by an electric motor 22 of the RWA 14 to a component coupled thereto, such as the coupling structure 24. Furthermore, the measured values of the operating parameter detected in this way are transmitted from the sensor 26 to the RWA 14 and/or the hand wheel actuator 18 and/or the control device 16. In some examples, several sensor units can also jointly form the sensor 26, whereby a mutual plausibility check and redundancy are provided.

The SBW steering system 12 also includes a steering wheel 28, to which the hand wheel actuator 18 is coupled at least indirectly, for example via a steering column. The hand wheel actuator 18 is configured to exert a feedback torque on the steering wheel 28 so that the driver of the vehicle 10 is provided a feeling of the lateral guidance of the vehicle 10. A driver of the vehicle 10 can use the steering wheel 28 to make steering inputs for the vehicle 10.

The SBW steering system 12 also includes at least one steering wheel sensor 30 that is configured to detect a steering wheel angle (e.g., a steering wheel position) of the steering wheel 28 with respect to a reference position, for example a center position (zero position). Consequently, the steering wheel sensor 30 can be used to detect steering inputs of the driver of the vehicle 10 based on the steering wheel 28. In such examples, a specific present steering angle request is defined. A present steering angle request corresponds to a specific present target angle according to which the steerable road wheels 20 shall be oriented. By modifying the steering wheel position, the present steering angle request is dynamically changed by the driver which in turn leads to a dynamic change of the present target angle. Accordingly, the present target angle is modified at a specific target angle speed which is determinable when comparing the present target angle with at least one preceding target angle of at least one preceding control period.

In some examples, the steering wheel sensor 30 is integral with the hand wheel actuator 18. However, in other embodiments, the steering wheel sensor 30 may be separate from the hand wheel actuator 18. The steering wheel sensor 30 is configured to communicate the sensed steering wheel angle with the RWA 14 and/or with the hand wheel actuator 18 and/or the control device 16.

In the illustrated example of FIG. 1, the control device 16 is depicted as being separate from the RWA 14 and the hand wheel actuator 18. In some examples, the control device 16 can also be partially or fully embedded in the RWA 14 or the hand wheel actuator 18 or can be formed of two individual portions both of which being assigned to different components, such as the RWA 14 and the hand wheel actuator 18. The control device 16 includes a data processing device. The control device 16 is configured to receive steering angle requests from the steering wheel sensor 30. Based on the received steering angle requests, the control device 16 can determine the corresponding present target angle and other variables or properties of the SBW system 12. In such examples, the control device 16 at least includes an angle controller 32 configured to determine the respective target angle depending on the received steering angle request.

The control device 16 is also configured to output respective control signals to the electric motor 22 of the RWA 14 or an inverter coupled thereto and/or the hand wheel actuator 18. For executing the respective control routines, the control device 16 can consider further parameters of the vehicle 10, for example the vehicle speed. Based on the control signal, an output torque is provided by the electric motor 22 of the RWA to orient the steerable road wheels 20 accordingly. Here, the output torque is exerted by the electric motor 22 of the RWA 14 on the coupling structure 24, so that indirectly an orientation of the steerable road wheels 20 is modified.

In some examples, the sensor 26 detects a property influenced by the RWA 14, such as a displacement of the coupling structure 24 and transmits the detected property to the control device 16 and/or the hand wheel actuator 18 which in turn determines a corresponding feedback torque that is output to the steering wheel 28. In some examples, the SBW steering system 12 can also include several components of the same type and generally the same function, for example several steering wheel sensors 30, whereby redundancy is ensured.

In some examples, the vehicle 10 includes a vehicle control device 34 that is configured to perform autonomous or semi-autonomous driving functionalities. For example, the vehicle control device 34 can autonomously affect the lateral control of the vehicle 10. To do this, the vehicle control device 34 can, for example, transmit a steering angle request to the RWA 14 and/or the hand wheel actuator 18 and/or the control device 16 of the SBW steering system 12. In the illustrated example of FIG. 1, the SBW steering system 12 is shown as a front axle steering system. The vehicle 10 and the SBW system 12 may, in some examples, also include further steerable road wheels 20, for example rear wheels, which are coupled to an additional common RWA 14.

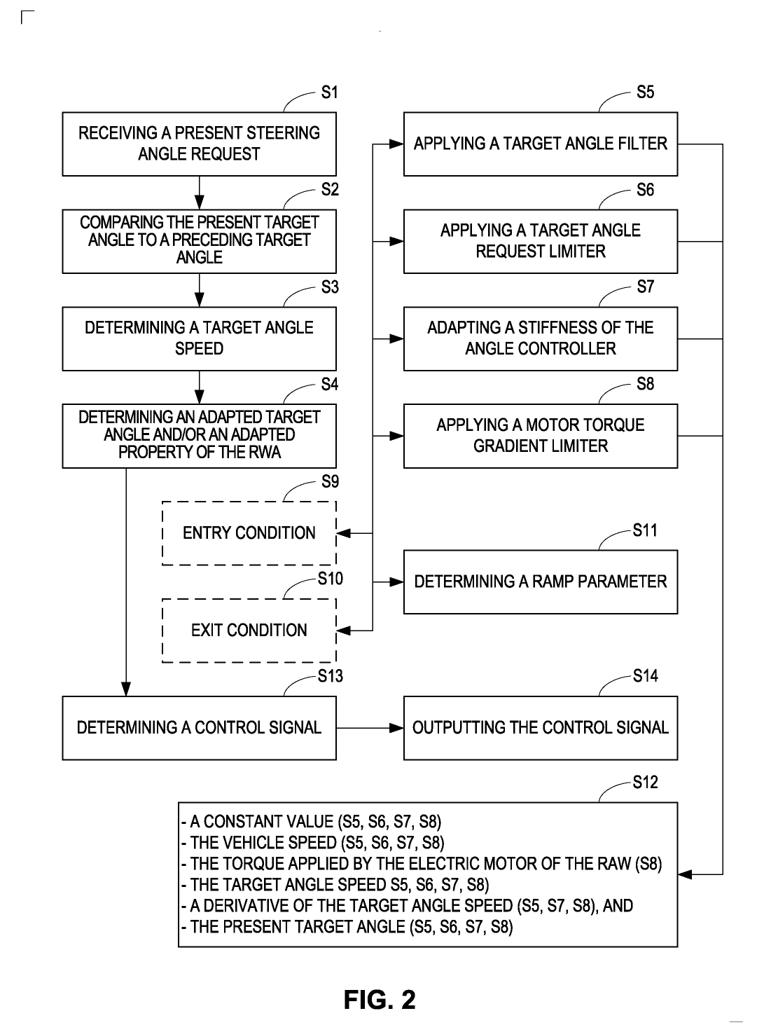

FIG. 2 depicts a flowchart representative of example machine readable instructions and/or example operations that may be executed, instantiated, and/or performed by the control device 16 to implement the SBW steering system of FIG. 1.. According to operation S1 a present steering angle request is received by the control device 16. The present steering angle request defines a present target angle for the steerable road wheels 20 of the vehicle 10.

In subsequent operation S2 the control device 16 compares the present target angle defined by the present steering angle request to at least one preceding target angle of at least one preceding steering angle request of at least one preceding control period. This means that the control device 16 evaluates the change of the present target angle in view of the at least one preceding target angle.

The method comprises the subsequent operation S3, in which the control device 16 determines a target angle speed based on the present target angle and the at least one preceding target angle. In such examples, the control device 16 may initially determine a difference between the present target angle and the at least one preceding target angle. Based on the time length of the control period the target angle speed may then be determined. In such examples, the target angle speed describes whether how fast or slow changes of the roadwheel angle are requested.

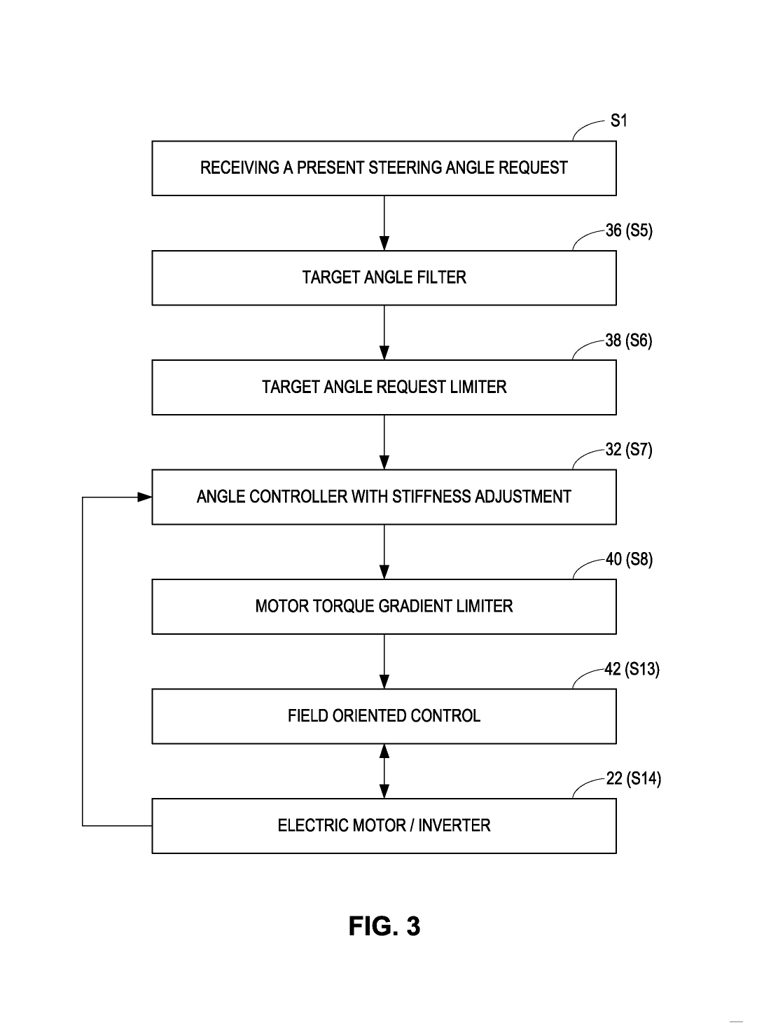

Afterwards, the control device 16 determines in operation S4 an adapted target angle and/or at least one adapted property of the RWA 14. Accordingly, the parameters of the SBW system 12 can be influenced. Operation S4 can be implemented by any one or multiple of optional operations S5 to S12. In such examples, FIG. 3 shows a schematic representation of the control procedure performed by the control device 16 according to an example. As already explained, the control procedure is based on the control device 16 initially receiving the present steering angle request.

According to optional operation S5 the control device 16 applies a target angle filter 36 to the present target angle defined by the received present steering angle request. The target angle filter 36 provides a smoothening of the present steering angle request. The characteristics of the target angle filter 36 can be modified by adapting its cut-off frequency and/or poles and/or zeros. In some examples, the target angle filter 36 may be a first-order low-pass filter or a higher-order low-pass filter. Due to the filtering effect of the target angle filter 36, the present target angle is modified into an adapted target angle determined by the control device 16.

Operation S4 can also be modified by optional operation S6, in which the control device 16 applies a target angle request limiter 38. The target angle request limiter 38 is configured to limit the derivative of the target angle speed. Therefore, the changes of the target angle speed can be efficiently maintained within an appropriate interval such that relatively large changes in the target angle speeds are prevented. Thus, the probability of noise can be reduced or even prevented. The target angle request limiter 38 limits the derivative of the target angle speed based on a target angle speed derivative interval defining a negative target angle speed derivative threshold and a positive target angle speed derivative threshold. Accordingly, the interval to which the target angle speed is restricted, can be configured in view of the respective SBW steering system 12.

Optional operation S7 can also be used to implement operation S4. The control device 16 includes an angle controller 32. The angle controller 32 includes control loops to determine as to how the electric motor 22 of the RWA 14 is to be controlled to achieve the present steering angle request, in some examples taking into account the adapted target angle. In such examples, the angle controller 32 may include feedback loops and/or feedforward loops. In some examples, properties of the angle controller 32 can be modified thereby adapting properties of the RWA 14. For example, according to optional operation S7, a stiffness of the angle controller 32 is adjusted. The stiffness of the angle controller 32 describes how direct a change of the orientation of the steerable road wheels 20 is performed in view of a respective steering angle request. The stiffness of the angle controller 32 can be influenced in optional operation S7 by modifying at least one or multiple of a gain of the angle controller 32, a pole of the angle controller 32, and/or a zero of the angle controller 32. Thereby, the characteristics of the angle controller 32 are adjusted which in turn leads to an adapted stiffness of the angle controller 32.

Operation S4 can also be modified by optional operation S8, in which a motor torque gradient limiter 40 is applied. The motor torque gradient limiter 40 is configured to limit a torque gradient of a torque output by the electric motor 22 of the RWA 14 to be smaller than a torque gradient threshold. For example, the rate of change of the torque which is output by the electric motor 22 of the RWA 14 is restricted to being below the torque gradient threshold. Therefore, fast torque changes output by the electric motor 22 are prevented. This also leads to a modified property of the RWA 14.

In principle, the determination of the adapted target angle and/or the adapted property of the RWA 14 can be active all time. However, in some examples, the determination can also rely on as to whether an entry condition or an exit condition has been met. Thus, in view of the optional operations S5 to S8, the control device 16 can further adapt the modification procedure performed within these optional operations for determining an adapted target angle and/or an adapted property of the RWA 14. In such examples, optional operation S9 can be applied, in which the control device 16 determines whether an entry condition is met. Accordingly, the adapted target angle and/or the at least one adapted property of the RWA 14 is determined by the control device 16 only if the target angle speed exceeds a first target angle speed threshold, and/or a vehicle speed of the vehicle is determined by the control device 16 to be below within a first vehicle speed threshold range, and/or the present target angle indicates an impending change of a direction of the target angle, and/or the present target angle indicates an impending stop of a steering movement.

In some examples, the control device 16 evaluates whether quick changes of the roadwheel angle are requested. A different entry condition is met if the derivative of the target angle changes the sign which corresponds to a change of the direction of the steering movement. The direction of the steering movement may, in some examples, be evaluated in view of a reference direction. In such examples, the reference direction may be the neutral direction (e.g., straight direction) of the steerable road wheels 20. Note that a change of the direction of the steering movement may independently occur from the coupling structure being positioned according to the center position (e.g., neutral position).

In some examples, the target angle is such that it indicates an impending stop of the steering movement. This means a target angle indicates that a specific target angle may be maintained in the near future. For example, a previous constant target angle speed may rapidly approach a speed of 0 deg/s. Hence, different scenarios may be evaluated by the control device 16 to determine whether an entry condition is met.

In some examples, the control device can determine an anticipated rapid change in direction or an anticipated sudden stop in movement based on a target angle of the steering wheel of the vehicle. For example, if the target angle accelerates towards zero degrees per second (e.g., decelerates) at a deceleration larger than a first threshold and a speed of the target angle is below a second threshold, the control device can determine that the rapid change in direction of the target angle request or the anticipated sudden stop in movement has occurred. In such an example, the control device can determine that either condition is met before the target angle speed is zero (e.g., before a noise from the road wheel actuator might occur).

In some examples, the method may also include optional operation S10 such that the control device 16 evaluates whether an exit condition is met. Thus, the determination of the adapted target angle and/or the at least one adapted property of the RWA 14 is deactivated if a direction of the present target angle compared to the at least one preceding target angle is changed relative to the reference direction and a tolerance time period (e.g., predetermined amount of time) has passed, or the target angle speed is larger than a second target angle speed threshold, and/or a first time period has passed after the control device 16 determined that the present target angle indicates an impending change of a direction of the target angle, or that the present target angle indicates an impending stop of a steering movement, and/or the present target angle speed is smaller than a third target angle speed threshold for a second time period, and/or the direction of the present target angle compared to the at least one preceding target angle did not change relative to the reference direction and the present target angle speed is larger than at least one preceding target angle speed of at least one preceding control period, and/or the vehicle speed of the vehicle 10 is determined to exceed a second vehicle speed threshold range. For example, the control device 16 may consider the vehicle speed to determine as to when a modification according to operation S4 has ended. For example, the control device 16 may end the modification of the present target angle and/or revert the at least one adapted property of the RWA 14 to an initial unmodified property of the RWA 14 if the vehicle speed of the vehicle 10 is determined to exceed a second vehicle speed threshold range. This means if the velocity of the vehicle 10 is increased to comparatively high vehicle speeds, the modification procedure as explained in view of operation S4 and optional operations S5 to S8 is ended. In this case, the control procedures performed by the control device 16 of the SBW system 12 revert back to regular operation.

In some examples, a change of direction of the present target angle took place and either an appropriate time period has passed, or the target angle speed has increased over the second target angle speed threshold again. Since noise primarily occurs at the point of the directional change, both criteria (e.g., sufficient time period or increasing target angle speed) indicate that the system configuration of the SBW system 12 moves away from the scenario in which noise may occur.

An exit condition can also be met by an additional scenario which relates to a purely time-based control procedure. It is assumed that after a sufficient time period the scenario, in which noise may occur, is not present anymore. In some examples, if the present target angle speed is smaller than a third target angle speed threshold for a second time period, the target angle speed may be assumed to be so small that noise cannot occur.

An additional end condition is met according to a scenario if the direction of the present target angle compared to the at least one preceding target angle did not change and the present target angle speed is larger than at least one preceding target angle speed of at least one preceding control period. In such an example, a directional change of the steering movement did not occur. Rather, the steering movement approached a scenario in which a directional change could possibly be assumed while, however, this directional change did not occur but the steering movement was performed according to a single direction only. In this case, noise cannot occur.

Entry and exit conditions according to operations S9 and S10 can be applied individually or in combination to any one or multiple of the optional operations S5 to S8. In addition, operation S4 and optional operations S5 to S8 can also be modified by optional operation S11. In this case, the control device 16 determines at least one ramp parameter. The single or multiple ramp parameters can be applied when modifying the present target angle into the adapted target angle and/or when modifying an initial (unmodified) property of the RWA 14 into an adapted property. In particular, the ramp parameter can be considered in view of any one of the target angle filter 36, the target angle request limiter 38, the stiffness adjustment of the angle controller 32, and the motor torque gradient limiter 40. Based on the ramp parameter smooth transitions between the unmodified and the modified configuration can be achieved. In some examples, the ramp parameter can also be considered when returning from the modified configuration into the unmodified configuration if the modification procedure applied by the control device 16 is ended, for example since the vehicle speed exceeds the second vehicle speed threshold.

Optional operations S5 to S8 can be further adjusted by considering specific input values based on which the respective modifications can be applied. Accordingly, optional operation S12 can be used to modify the characteristics of the target angle filter 36, the target angle request limiter 38, the stiffness adjustment of the angle controller 32, and the motor torque gradient limiter 40. In optional operation S12, several variables are listed in view of the operations which can be modified thereby (e.g., specified in brackets).

Different constant values can be used to adapt the cut-off frequency and/or poles and/or zeros of the target angle filter 36, to individually or cooperatively adapt the negative target angle speed derivative threshold and the positive target angle speed derivative threshold of the target angle request limiter 38, to adapt the gain and/or the pole and/or the zero of the angle controller 32, and/or to adapt the torque gradient based on the motor torque gradient limiter 40. Also, the vehicle speed, and/or the target angle speed, and/or the present target angle can be used instead or in addition to different constant values in such examples. Moreover, the derivative of the target angle speed can be used to adapt the cut-off frequency and/or poles and/or zeros of the target angle filter 36, to adapt the gain and/or the pole and/or the zero of the angle controller 32, and/or to adapt the torque gradient based on the motor torque gradient limiter 40. In addition, the torque applied by the electric motor 22 of the RWA 14 can be used to adapt the torque gradient based on the motor torque gradient limiter 40.

Subsequent to operation S4 the method comprises operation S13 in which the control device 16 determines a control signal for the electric motor 22 based on the steering angle request, the adapted target angle and/or the adapted property of the RWA 14. FIG. 3 shows that a field-oriented control 42 of the control device 16 is applied in such examples.

Afterwards, the method comprises operation S14 in which the control device 16 outputs the control signal determined in operation S13 to the electric motor 22 or an inverter coupled thereto. Subsequently, the electric motor 22 applies a torque such that the orientation of the steerable road wheels 20 is modified based on the steering angle request, the adapted target angle, and/or the adapted property of the RWA 14.

Example instructions and/or operations of FIGS. 2 and 3 may be implemented using executable instructions (e.g., computer-readable, and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/ or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

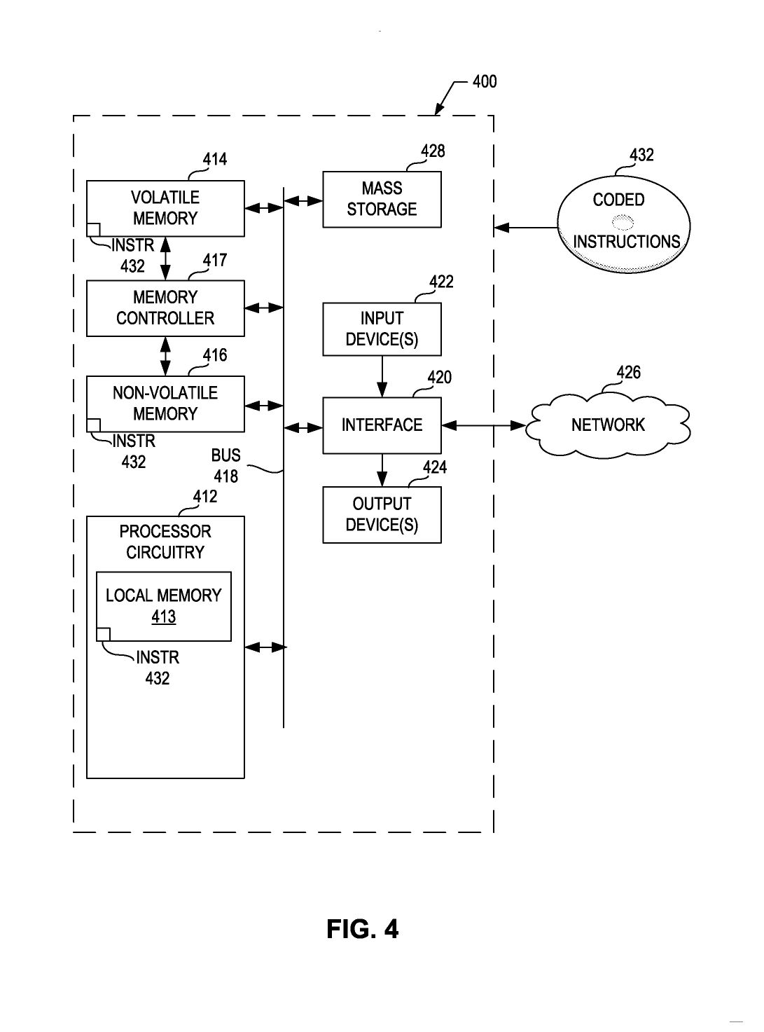

FIG. 4 is a block diagram of an example programmable circuitry platform 400 structured to execute and/or instantiate the example machine-readable instructions and/or the example operations of FIGS. 2 and 3 to implement examples disclosed herein. The programmable circuitry platform 400 can be, for example, a control device, an electronic control unit (ECU), a self-learning machine (e.g., a neural network), or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 412 may be implemented by one or more semiconductor based (e.g., silicon based) devices.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, an audio sensor, a microphone, a camera (still or video), a button, a touchscreen, and/or a voice recognition system.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 432, which may be implemented by the machine-readable instructions of FIGS. 2 and 3, may be stored in the mass storage device 428, in the volatile memory 414, in the non-volatile memory 416, and/or on at least one non-transitory computer readable storage medium such as a CD or DVD which may be removable.

All threshold values, time periods, and constant values can be adapted according to the respective needs to tailor the described method.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that reduce noise in SBW steering systems. Further examples and combinations thereof include the following:

Example 1 includes a vehicle comprising a hand wheel actuator, a road wheel actuator, and a steering controller to instantiate or execute machine readable instructions to determine a speed of a steering input to the hand wheel actuator, determine an acceleration of the steering input, and in response to the acceleration being a deceleration larger than a first threshold and the speed being below a second threshold, apply a gradient torque limit to the road wheel actuator.

Example 2 includes the vehicle of example 1, wherein the gradient torque limit is based on a currently applied torque of the road wheel actuator.

Example 3 includes the vehicle of any one or more of examples 1-2, wherein the gradient torque limit is based on a speed of the vehicle.

Example 4 includes the vehicle of any one or more of examples 1-3, wherein the steering controller is to remove application of the gradient torque limit in response to the speed being below the second threshold for a predetermined amount of time.

Example 5 includes the vehicle of any one or more of examples 1-4, wherein in response to the acceleration being a deceleration larger than the first threshold and the speed being below the second threshold, the steering controller is to apply a gradient target angle limit to a target angle of the road wheel actuator.

Example 6 includes the vehicle of any one or more of examples 1-5, wherein the steering controller is to apply a filter to a target angle of the road wheel actuator.

Example 7 includes the vehicle of example 6, wherein in response to the acceleration being a deceleration larger than the first threshold and the speed being below the second threshold, the steering controller is to cause a change to the filter.

Example 8 includes the vehicle of any one or more of examples 1-7, wherein in response to the acceleration being a deceleration larger than the first threshold and the speed being below the second threshold, the steering controller is to cause a change to a stiffness of the steering controller.

Example 9 includes the vehicle of any one or more of examples 1-8, wherein in response to the acceleration being a deceleration larger than the first threshold and the speed being below the second threshold, the steering controller is to apply a target angle acceleration limit to a target angle of the steering controller.

Example 10 includes a non-transitory computer readable storage medium comprising instructions to cause programmable circuitry to at least determine a speed of a steering input to a hand wheel actuator of a vehicle, determine an acceleration of the steering input, and in response to the acceleration being a deceleration larger than a first threshold and the speed being below a second threshold, apply a gradient torque limit to a road wheel actuator of the vehicle.

Example 11 includes the non-transitory computer readable storage medium of example 10, wherein the gradient torque limit is based on a currently applied torque of the road wheel actuator.

Example 12 includes the non-transitory computer readable storage medium of any one or more of examples 10-11, wherein the gradient torque limit is based on a speed of the vehicle.

Example 13 includes the non-transitory computer readable storage medium of any one or more of examples 10-12, wherein the programmable circuitry removes application of the gradient torque limit in response to the speed being below the second threshold for a predetermined amount of time.

Example 14 includes the non-transitory computer readable storage medium of any one or more of examples 10-13, wherein programmable circuitry is to apply a filter to a target angle of the road wheel actuator.

Example 15 includes the non-transitory computer readable storage medium of example 14, wherein in response to the acceleration being a deceleration larger than the first threshold and the speed being below the second threshold, the programmable circuitry is to cause a change to the filter.

Example 16 includes the non-transitory computer readable storage medium of any one or more of examples 10-15, wherein in response to the acceleration being a deceleration larger than the first threshold and the speed being below the second threshold, the programmable circuitry is to cause a change to a stiffness of the programmable circuitry.

Example 17 includes the non-transitory computer readable storage medium of any one or more of examples 10-16, wherein in response to the acceleration being a deceleration larger than the first threshold and the speed being below the second threshold, the steering controller is to apply a target angle acceleration limit to a target angle of the steering controller.

Example 18 includes a method comprising determining a speed of a steering input to a hand wheel actuator of a vehicle, determining an acceleration of the steering input, and in response to the acceleration being a deceleration larger than a first threshold and the speed being below a second threshold, applying a gradient torque limit to a road wheel actuator of the vehicle.

Example 19 includes the method of example 18, wherein the gradient torque limit is based on a currently applied torque of the road wheel actuator.

Example 20 includes the method of any one or more of examples 18-19, wherein the gradient torque limit is based on a speed of the vehicle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising a hand wheel actuator; a road wheel actuator; and a steering controller to instantiate or execute machine readable instructions to: determine a speed of a steering input to the hand wheel actuator; determine an acceleration of the steering input; and in response to the acceleration being a deceleration larger than a first threshold and the speed being below a second threshold, apply a gradient torque limit to the road wheel actuator.

2. The vehicle of claim 1, wherein the gradient torque limit is based on a currently applied torque of the road wheel actuator.

3. The vehicle of claim 1, wherein the gradient torque limit is based on a speed of the vehicle.

4. The vehicle of claim 1, wherein the steering controller is to remove application of the gradient torque limit in response to the speed being below the second threshold for a predetermined amount of time.

5. The vehicle of claim 1, wherein in response to the acceleration being a deceleration larger than the first threshold and the speed being below the second threshold, the steering controller is to apply a gradient target angle limit to a target angle of the road wheel actuator.

6. The vehicle of claim 1, wherein the steering controller is to apply a filter to a target angle of the road wheel actuator.

7. The vehicle of claim 6, wherein in response to the acceleration being a deceleration larger than the first threshold and the speed being below the second threshold, the steering controller is to cause a change to the filter.

8. The vehicle of claim 1, wherein in response to the acceleration being a deceleration larger than the first threshold and the speed being below the second threshold, the steering controller is to cause a change to a stiffness of the steering controller.

9. The vehicle of claim 1, wherein in response to the acceleration being a deceleration larger than the first threshold and the speed being below the second threshold, the steering controller is to apply a target angle acceleration limit to a target angle of the steering controller.

10. A non-transitory computer readable storage medium comprising instructions to cause programmable circuitry to at least: determine a speed of a steering input to a hand wheel actuator of a vehicle; determine an acceleration of the steering input; and in response to the acceleration being a deceleration larger than a first threshold and the speed being below a second threshold, apply a gradient torque limit to a road wheel actuator of the vehicle.

11. The non-transitory computer readable storage medium of claim 10, wherein the gradient torque limit is based on a currently applied torque of the road wheel actuator.

12. The non-transitory computer readable storage medium of claim 10, wherein the gradient torque limit is based on a speed of the vehicle.

13. The non-transitory computer readable storage medium of claim 10, wherein the programmable circuitry removes application of the gradient torque limit in response to the speed being below the second threshold for a predetermined amount of time.

14. The non-transitory computer readable storage medium of claim 10, wherein programmable circuitry is to apply a filter to a target angle of the road wheel actuator.

15. The non-transitory computer readable storage medium of claim 14, wherein in response to the acceleration being a deceleration larger than the first threshold and the speed being below the second threshold, the programmable circuitry is to cause a change to the filter.

16. The non-transitory computer readable storage medium of claim 10, wherein in response to the acceleration being a deceleration larger than the first threshold and the speed being below the second threshold, the programmable circuitry is to cause a change to a stiffness of the programmable circuitry.

17. The non-transitory computer readable storage medium of claim 10, wherein in response to the acceleration being a deceleration larger than the first threshold and the speed being below the second threshold, the steering controller is to apply a target angle acceleration limit to a target angle of the steering controller.

18. A method comprising: determining a speed of a steering input to a hand wheel actuator of a vehicle; determining an acceleration of the steering input; and in response to the acceleration being a deceleration larger than a first threshold and the speed being below a second threshold, applying a gradient torque limit to a road wheel actuator of the vehicle.

19. The method of claim 18, wherein the gradient torque limit is based on a currently applied torque of the road wheel actuator.

20. The method of claim 18, wherein the gradient torque limit is based on a speed of the vehicle.
